(19) United States
(12) Patent Application Publication
(10) Pub. No.: US 2005/0128930 A1
(43) Pub. Date: Jun. 16, 2005

(54) Optical information-recording medium and method for producing the same

(75) Inventors: Masashi Suenaga, Moriya-shi (JP); Yusuke Takahashi, Moriya-shi (JP); Katsunori Miyata, Yuki-gun (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/004,998

(22) Filed: Dec. 7, 2004

(30) Foreign Application Priority Data
Dec. 12, 2003 (JP) 2003-415438
Feb. 24, 2004 (JP) 2004-048520

(51) Int. Cl. G11B 7/24

(52) U.S. Cl. 369/275.4; 369/288

(57) ABSTRACT

An optical information-recording medium includes a substrate formed with a plurality of lands and grooves, and a recording layer and a reflective layer formed on the substrate. The grooves include a first groove, a second groove in which pits are formed, and a third groove which is arranged between the first groove and the second groove and which is formed with a groove having a width wider than a width of the first groove. Land pits, which indicate position information, are formed at a land portion in an area in which the second groove is provided. Shifted land prepits, which indicate position information, are formed in areas in which the first and third grooves are provided. It is possible to obtain a stable radial push-pull signal, and it is possible to suppress the reproduction error.

### BACKGROUND OF THE INVENTION

1. Field of the Invention

The present invention relates to an optical information-recording medium. In particular, the present invention relates to an optical information-recording medium on which media information such as the manufacturer's name and the information concerning copyright protection measures is written in a form of prepits.

2. Description of the Related Art

In recent years, DVD (digital versatile disk), which has the recording capacity several times that of CD (compact disk), is widely used as an information-recording medium for recording information such as voices and images of movies or the like. In addition to DVD, those having been commercially available as products include DVD-R (write-once type digital versatile disk) on which information is recordable only once by the user, and DVD-RW (rewritable type digital versatile disk) on which information is rewritable. Such products are available widely and generally as information-recording media having large capacities.

Usually, in the case of DVD-R and DVD-RW, the information about the manufacturer of the disk and the information concerning copyright protection measures (hereinafter referred to as “media information”) are previously stored on the innermost circumferential portion and the outermost circumferential portion of the disk. The media information is recorded by modifying the recording layer, for example, by radiating a light beam by using a recording apparatus at the final stage of the steps of producing the disk. On the other hand, a method is disclosed, in which the media information is not recorded in the recording layer, but the media information is recorded in a form of emboss pits, i.e., in-groove pits previously formed on the bottom of the groove of the substrate at the stage of producing the substrate of the disk (see, for example, Japanese Patent Application Laid-open No. 2001-67733 (pp. 5-6, FIGS. 1 to 3)). FIG. 1 shows a part of an optical information-recording medium manufactured by using this method. FIG. 1A shows a partial magnified plan view illustrating the optical information-recording medium, which schematically depicts an area (hereinafter referred to as “in-groove pit area”) in which the in-groove pits are formed. FIGS. 1B and 1C show a cross section taken along a line 1B-1B shown in FIG. 1A and a cross section taken along a line 1C-1C shown in FIG. 1A respectively.

As shown in FIG. 1B, the depth dp″, which ranges from the land surface 110a to the bottom surface (lowermost surface) 107a of the in-groove pit 107 of the substrate 101 formed with lands and grooves, is formed to be deeper than the depth dg″ which ranges from the land surface 101a to the bottom surface (lowermost surface) 105a of the groove 105. Accordingly, when the recording layer 102 and the reflective layer 103 are formed on the pattern formation surface of the substrate 101, a difference appears in the surface height of each of the layers to be formed between the portion at which the in-groove pit 107 is formed and the groove portion at which the in-groove pit 107 is not formed. Therefore, the data such as the media information can be recorded in the groove by utilizing the difference in the depth between the in-groove pit portion and the groove portion.

However, when the information is actually recorded and reproduced by using the optical information-recording medium having the in-groove pits as described above, if the tracking is performed for the boundary portion between the in-groove pit area and the area (hereinafter referred to as “groove area”) in which only the groove is formed as the recording area on the user side, then an error is confirmed such that the tracking is often deviated. As shown in FIG. 11, this phenomenon is caused by the fact that the side wall of the adjoining land 152 is eroded or scraped when the in-groove pit 151 is formed on the substrate. When the side wall of the adjoining land 152 is eroded, the land 152, which is disposed between the in-groove pit 151 and the groove 153, has the upper surface area which is smaller than the upper surface area of the land 154 that is disposed between the ordinary grooves 153. In response thereto, the differences also appear in the areas of the reflective layer and the recording layer formed between the land 152 and the land 154. When the groove 153, which is disposed between the land 152 and the land 154, is subjected to the tracking by using the light spot SP, the difference arises between the light amount of the reflected light beam RF1 obtained from the land 154 and the light amount of the reflected light beam RF2 obtained from the land 152, even when the light spot SP is positioned at the center of the groove 153. As a result, the radial push-pull signal is offset. Therefore, it is impossible to perform any satisfactory tracking for the groove, resulting in the increase in the jitter and the decrease in the modulation degree. Further, the tracking is deviated or departed in some cases.

When the radial push-pull signal is actually detected, the light spot having a diameter φ=about 1 μm is subjected to the scanning in the radial direction over the optical information-recording medium, in the case of the use of an optical pickup having a wavelength λ=650 nm and a numerical aperture NA=0.6. In this situation, the optical information-recording medium is rotated at a high speed. Therefore, the light spot is not subjected to the scanning in the direction perpendicular to the tracking direction, but the light spot is subjected to the scanning in a direction which forms a gentle angle with respect to the tracking direction. The radial push-pull signal does not have any frequency characteristic to such an extent that the pits can be resolved and detected. Therefore, the operation is consequently equivalent to the detection of a wide width groove at the in-groove pit portion formed to be deeper than the groove. Therefore, in this case, a situation arises such that the groove width is extremely changed with the borderline of the boundary portion between the in-groove pit area and the groove area, and the radial push-pull signal is disturbed.

In particular, in the case of DVD-R and DVD-RW, the tracking is performed by using the radial push-pull signal. The tracking error is caused by the offset and/or the disturbance of the radial push-pull signal. Therefore, it is necessary for DVD-R and DVD-RW to avoid the tracking error.

In the medium structure as shown in FIGS. 1 and 11, land prepits (hereinafter appropriately referred to as “LPP”) are provided as position information on the land. Recently, in order to suppress the error after the recording, a system has been developed, in which a groove portion is bent to protrude in the radial direction, and position information is carried on the bent portion. The bent portion is called “shifted land prepit” (hereinafter appropriately referred to as “SLPP”), which is preferable for high recording speed DVD-R. However, in the in-groove pit system as described above, the pits having the deeper depth are formed in the groove in order to previously record information. In the case of the SLPP system wherein the information, which resides in the recording of the position information about the disk, is based on the bent portion, it has been revealed that the in-groove pit has a distorted shape as shown in FIG. 12. If such a shape is formed, a problem arises in relation to the reproduction of information carried by the in-groove pit. Further, another problem also arises in relation to the standard of DVD-R.

### SUMMARY OF THE INVENTION

A first object of the present invention is to provide an optical information-recording medium which makes it possible to obtain a stable radial push-pull signal even when the tracking is performed for a boundary portion between an in-groove pit area and a groove area, and a method for producing the same.

A second object of the present invention is to stably provide an information-recording medium which makes it possible to simultaneously suppress errors in an in-groove pit area and a user data area in which an user records data on the information-recording medium formed with in-groove pits such as DVD-R, and a method for producing the same.

According to a first aspect of the present invention, there is provided an information-recording medium comprising a substrate in which a plurality of lands and grooves are formed and a plurality of tracks are comparted, and a recording layer and a reflective layer which are formed on the substrate, wherein:
the grooves include a first groove; a second groove in which pits are formed; and a third groove which is arranged between the first groove and the second groove and which has a groove width wider than a width of the first groove;
pits, which indicate position information, are formed on the land disposed in an area in which the second groove is formed; and
shifted land prepits which indicate position information are provided in areas in which the first and third grooves are formed.

In the case of the optical information-recording medium of the present invention, the third groove (boundary groove), which has the width wider than the width of the first groove, is arranged between the first groove and the second groove. Accordingly, it is possible to suppress the offset and the tracking error at the boundary portion. Further, the land prepits (LPP) are provided in the in-groove pit area of the information-recording medium, and the shifted land prepits (SLPP) are provided in the user data area for recording the data so that the position information is carried on the pits. Accordingly, it is possible to appreciate the advantages of the LPP system and the SLPP system, and it is possible to reduce the error. Further, the individual characteristics, which are required for the DVD-R standard, can be satisfied in both of the in-groove pit area and the groove area.

The method for producing the optical information-recording medium of the present invention is useful to produce the optical information-recording medium of the present invention.

### BRIEF DESCRIPTION OF THE DRAWINGS

FIG. 1A shows a schematic top view illustrating a part of an optical information-recording medium having conventional in-groove pits, FIG. 1B shows a sectional view taken along a line 1B-1B shown in FIG. 1A, and FIG. 1C shows a sectional view taken along a line 1C-1C shown in FIG. 1A.

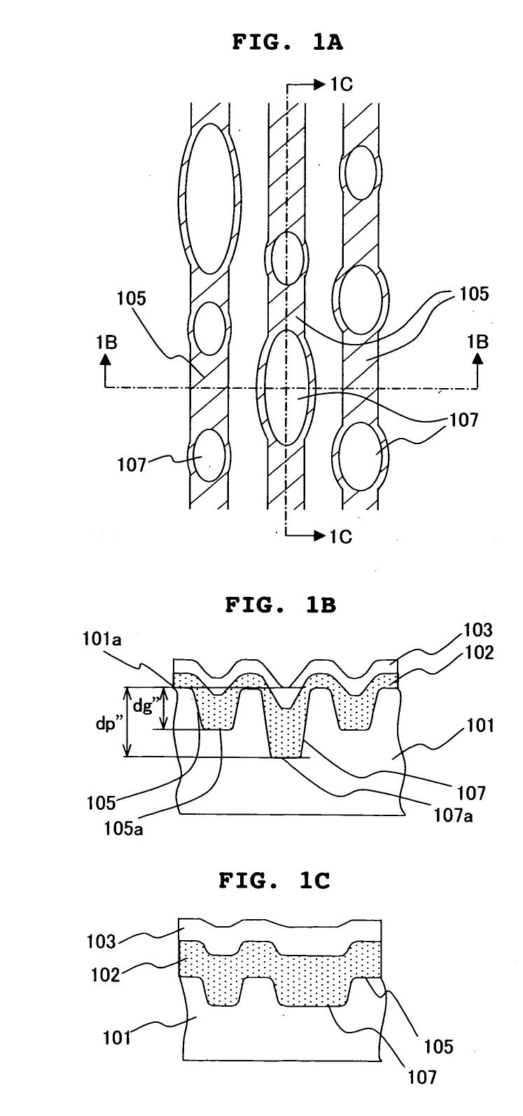

FIGS. 2A to 2C illustrates a method for manufacturing a glass master disk in an embodiment.

FIG. 3 shows the time-dependent change of the exposure intensity of the laser beam to be radiated onto the glass master disk in the embodiment.

FIG. 4A shows a schematic top view illustrating a part of the glass master disk immediately after the photoresist exposure and the development in the embodiment, and FIG. 4B shows a sectional view taken along a line 4B-4B shown in FIG. 4A.

FIGS. 5A and 5B schematically show an area in which no in-groove pit is formed in the embodiment.

FIGS. 6A to 6D illustrate a method for manufacturing the glass master disk in relation to an in-groove pit formation area in the embodiment.

FIGS. 7A to 7E illustrate a method for manufacturing the glass master disk in relation to an area in which no in-groove pit is formed in the embodiment.

FIG. 8 shows a schematic perspective view illustrating a pattern formation surface of a substrate obtained in the embodiment.

FIG. 9 shows a schematic view illustrating the substrate obtained in the embodiment.

FIG. 10A shows a schematic top view illustrating those disposed in the vicinity of in-groove pits of the substrate in the embodiment, and FIG. 10B shows a schematic sectional view illustrating a state in which a recording layer and a reflective layer are formed on the substrate in addition to a cross section taken along a line 10B-10B shown in FIG. 10A.

FIG. 11 illustrates the cause of the occurrence of the tracking error which arises at the boundary portion between the groove formation area and the in-groove pit formation area.

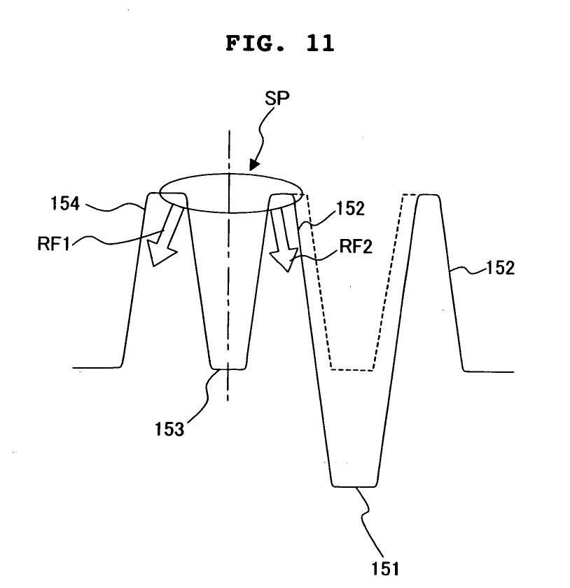

FIGS. 12A and 12B schematically shows a situation in which an in-groove pit is formed in accordance with the SLPP system.

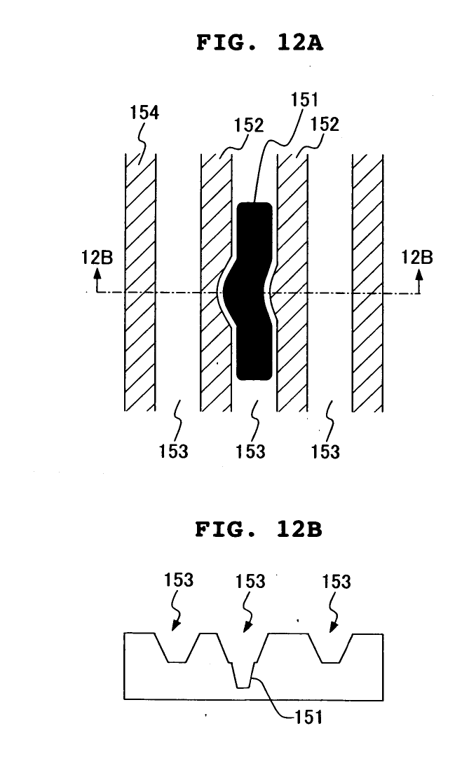

FIG. 13 shows the time-dependent change of the exposure intensity of the laser beam to be radiated on the glass master disk in the embodiment.

FIGS. 14A and 14B schematically show a first groove area in the present invention.

FIG. 15 shows an arrangement of Physical sector of the optical information-recording medium in the present invention.

FIG. 16 shows a structure of Lead-in in the present invention.

### DESCRIPTION OF THE PREFERRED EMBODIMENTS

An explanation will be made below with reference to the drawings about embodiments of the information-recording medium of the present invention and the method for producing the same. However, the present invention is not limited thereto.

Method for Manufacturing Master Disk and Stamper for Manufacturing Substrate

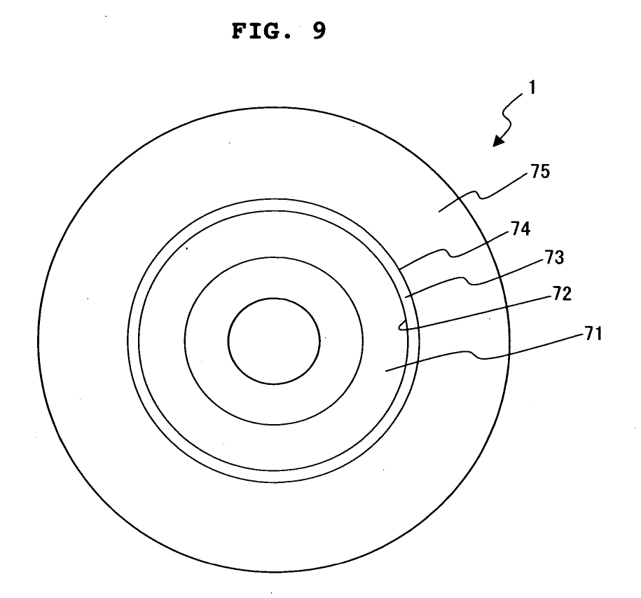

As shown in FIG. 9, a substrate 1, which is usable for the optical information-recording medium of the present invention, is comparted into a groove area 71, a boundary groove area 72, an in-groove pit area 73, a boundary groove area 74, and a groove area 75 in this order from the inner circumferential side of the substrate 1.

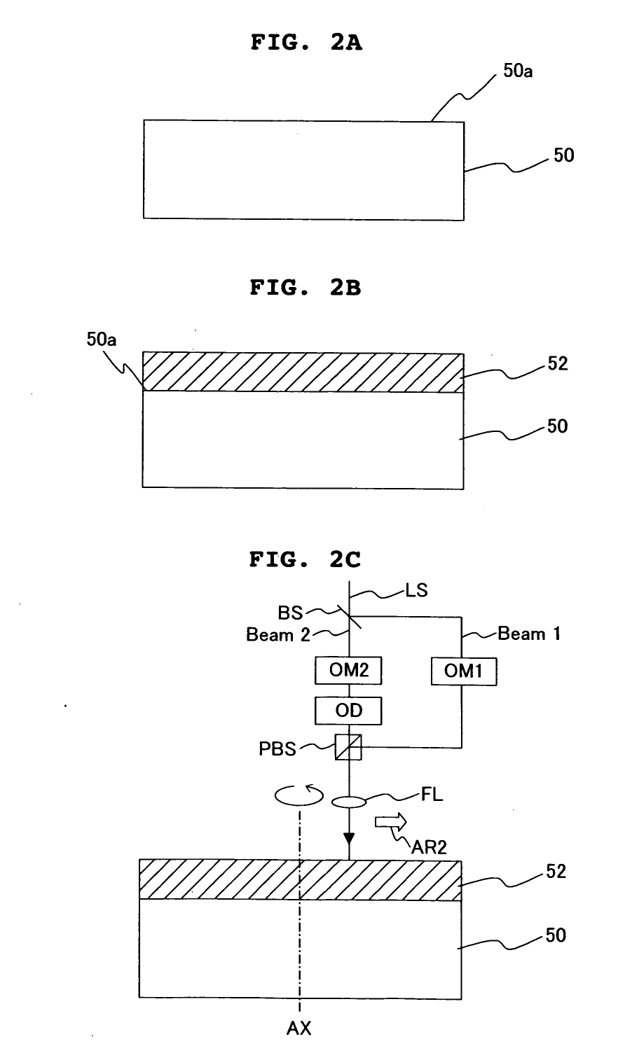

An explanation will be made with reference to FIGS. 2 to 9 about a method for manufacturing a master disk and a stamper for manufacturing the substrate 1. As shown in FIG. 2A, a glass master disk 50 was prepared, which had a flat surface 50a and which had a diameter of 200 mm and a thickness of 6 mm. Subsequently, as shown in FIG. 2B, a photoresist 52 was uniformly applied to have a thickness of 220 nm on the surface 50a of the glass master disk 50 by using the spin coat method. Subsequently, the glass master disk 50, on which the photoresist 52 had been formed, was installed to an unillustrated cutting apparatus (master disk exposure apparatus). The cutting apparatus principally includes, for example, a Kr gas laser light source which oscillates a laser beam having a wavelength of 351 nm, optical modulators each composed of an acousto-optic modulator, an optical deflector, a light-collecting lens, and a driving unit for rotating the glass master disk. As shown in FIG. 2C, the laser beam LS, which is radiated from the laser light source of the cutting apparatus, is divided into two by a beam splitter BS. Beam 1 passes through the optical modulator OM1, and Beam 2 passes through the optical modulator OM2 and the optical deflector OD. After that, Beams 1 and 2 are combined again by a beam splitter PBS, and the combined laser beam is radiated onto the photoresist 52 on the glass master disk 50 through the light-collecting lens FL. In this procedure, the glass master disk 50 was rotated at a predetermined number of revolutions about the central axis AX of the glass master disk 50. The laser beam LS was moved (arrow AR2) so that the radiation position of the laser beam LS on the glass master disk 50 was moved from the inner side to the outer side of the glass master disk 50 in the radial direction of the glass master disk 50.

Beam 1 was used to perform the exposure for LPP in the in-groove pit area, and Beam 2 was used to perform the exposure for grooves, in-groove pits, and SLPP respectively. The exposure is performed simultaneously by using Beam 1 and Beam 2. However, in order to perform the explanation comprehensively, the following explanation will be made separately for the exposure operations with Beam 1 and Beam 2.

Exposure for LPP with Beam 1

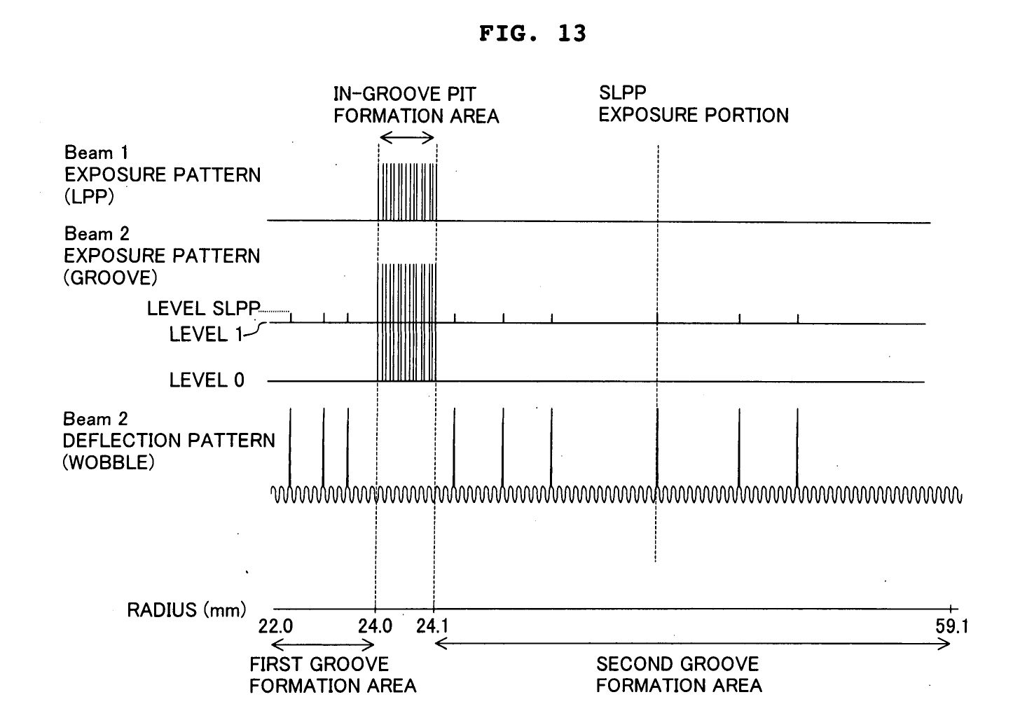

The exposure intensity of the laser beam LS to be radiated onto the glass master disk 50 is changed by using the optical modulator OM1 through which Beam 1 passes, while moving the laser beam LS as described above. LPP is formed on only the land existing in the in-groove pit area. Therefore, as illustrated in an exposure pattern (LPP) for Beam 1 shown in FIG. 13, the input is made into the optical modulator during the exposure only when the exposure is performed for the in-groove pit area corresponding to the area of the disk radii of 24.0 mm to 24.1 mm.

Exposure for Groove, In-Groove Pit, and SLPP with Beam 2

As shown in FIG. 2C, the bending in the disk radial direction, i.e., the wobble is changed by using the optical deflector OD in order to form SLPP while changing the exposure intensity of the laser beam LS to be radiated onto the glass master disk 50 by using the optical modulator OM2 through which Beam 2 passes, while moving the laser beam LS. The area shown in FIG. 13, which has the radii of 22.0 mm to 24.0 mm, corresponds to the groove area 71 of the substrate 1 shown in FIG. 9 (hereinafter referred to as “first groove formation area”). The area, which has the radii of 24.0 mm to 24.1 mm, corresponds to the in-groove pit area 73 of the substrate 1 (hereinafter referred to as “in-groove pit formation area”). Further, the area, which has the radii of 24.1 mm to 59.1 mm, is the user data area, which corresponds to the groove area 75 of the substrate 1 (hereinafter referred to as “second groove formation area”). Boundary groove areas, each of which corresponds to the length of one track, are provided at the boundaries between the in-groove pit area and the groove areas 71 and 75 respectively.

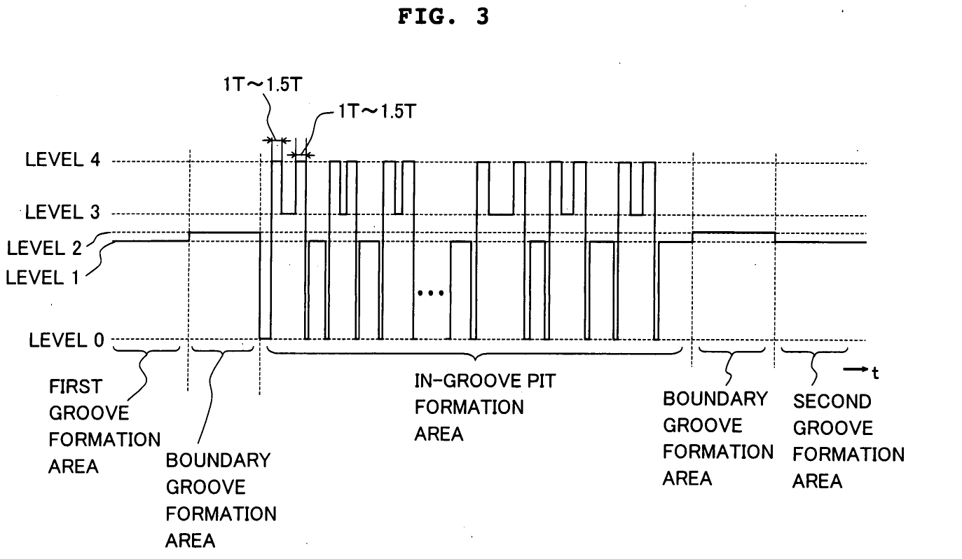

In this embodiment, the intensity of the light was controlled as shown in FIG. 3 in order to perform the exposure for the areas as described above. The exposure intensity, which was used to form the grooves in each of the first and second groove formation areas, was set to Level 1 (groove level).

As shown in FIG. 3, the exposure intensity of the laser beam was changed to be at the three stages of Levels 1, 3, and 4 in the in-groove pit formation area. The exposure intensity was set to be at the two stages of levels of Level 4 and Level 3 for forming the portion corresponding to the in-groove pit (hereinafter referred to as “in-groove pit formation portion”) in the in-groove pit formation area. The exposure intensity was set to be at the groove level for the groove portions other than the above. In this embodiment, when the signal output for Level 4 was 100%, then the signal output for Level 3 was 63%, and the signal output for the groove level was 50% for the inner circumference and 55% for the outer circumference to make the setting so that the exposure intensity was continuously changed between the inner circumference and the outer circumference. The boundary groove area, which was disposed at the boundary between the groove area and the in-groove pit area, was provided in the amount corresponding to one track. The exposure level for the boundary groove was 55% (Level 2) which was higher than the groove level.

The exposure is performed so that SLPP is formed over the entire area of the first groove formation area and the second groove formation area (radii of 22 mm to 24.0 mm and 24.1 mm to 59.1 mm). SLPP is formed by changing the wobble amount (beam movement amount in the radial direction) and the exposure intensity of Beam 2 for performing the exposure for the groove. In the portion for forming SLPP, the exposure intensity was the intensity (hereinafter referred to as “Level SLPP”) which was +4% of Level 1 (groove level) in the radius as recognized for the SLPP exposure portion in the exposure pattern for Beam 2 shown in FIG. 13. Further, Beam 2 was wobbled in the radial direction at about 140 KHz as shown in the deflection pattern of Beam 2 in FIG. 13 by using the optical deflector (OD). For the wobble at about 140 KHz, the signal at the wobble level is inputted so that the amplitude is 15 nmₚ₋ₚ. When SLPP was formed, the signal at SLPPw level was applied to the optical deflector to increase the wobble amount of the portion. In this embodiment, SLPPw level was adjusted so that the amplitude of the SLPP portion was 150 nm. Although not shown in FIG. 3, SLPP was also provided in the boundary groove area.

As shown in FIG. 3, when the in-groove pit formation portion was subjected to the exposure, the exposure was performed at Level 4 during the period from the start to 1 T to 1.5 T (T: clock cycle). Subsequently, the exposure was performed while lowering the exposure intensity to Level 3. Further, the exposure intensity was returned to Level 4 again to perform the exposure during the period until the completion of the in-groove pit formation portion of 1 T to 1.5 T. Accordingly, the width of the in-groove pit formation portion in the radial direction of the master disk is not widened in the vicinity of the intermediate portion of the in-groove pit formation portion, for the following reason. That is, the totalized exposure amount was decreased during the period of the exposure at Level 3, and the exposure range is suppressed from being widened in the radial direction of the master disk corresponding thereto. The in-groove pits in the in-groove pit area of the substrate are formed to provide a desired pattern with any one of the channel bit lengths of 3 T to 11 T or 14 T in the direction of the track (groove). The width is scarcely widened by the influence of the totalized exposure amount in the in-groove pit formation portion formed with 3 T as the shortest channel bit length. Therefore, the exposure intensity was not switched at the two stages unlike the above, and the exposure was performed by being fixed to Level 4. In this embodiment, the exposure intensity was switched as described above. Accordingly, the in-groove pit formation portion, which had the channel bit length longer than the shortest channel bit length, had the width which successfully had the size equivalent to the width of the in-groove pit formation portion having the shortest channel bit length. The clock cycle T is appropriately adjustable depending on the reproducing apparatus to be used.

Further, in this embodiment, as shown in FIG. 3, the period, in which the exposure intensity of the laser beam was temporarily zero (zero level), was provided every time when the exposure intensity was switched from Level 4 to Level 1 (groove level) or from Level 1 to Level 4. The period of Level 0 was changed depending on the channel bit length of the pit to be formed. When the exposure was performed for the in-groove pit formation portion having the shortest channel bit length 3 T, the period of Level 0 was 0.2 T. Accordingly, the processing accuracy is improved for the in-groove pit formation portion of the master disk.

Next, the glass master disk, on which the photoresist had been photosensitized, was taken out from the cutting apparatus to perform the development process. Also in this case, for the convenience of the explanation, the in-groove pit area and the groove area will be separately explained.

Development Process after Exposure for In-Groove Pit Portion

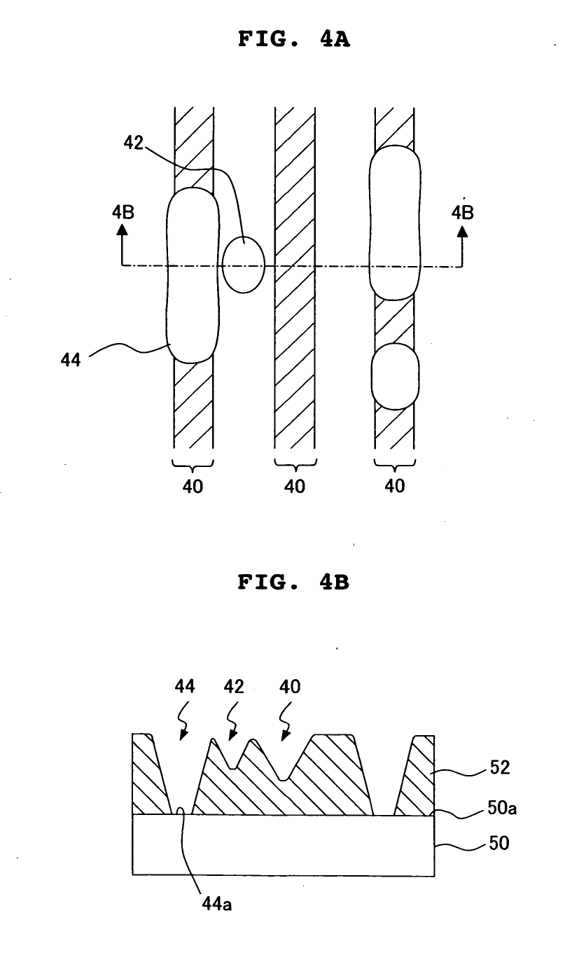

As a result of the development, as shown in FIGS. 4A and 4B, a groove formation section 40, an in-groove pit formation section 44, and a land prepit formation section 42 in the in-groove pit formation area were formed on the glass master disk 50. Each of the groove formation section 40 and the land prepit formation section 42 is formed so that the cross section has a V-shaped groove shape. In this situation, the groove depth of the land prepit formation section 42 is deeper than the groove depth of the groove formation section 40. The photoresist 52 on the glass master disk 50 is removed at the in-groove pit formation section 44 as a result of the development process. As shown in FIG. 4B, the surface 50a of the glass master disk 50 appears as an exposed section 44a.

Development Process after Exposure for Groove Portion and Boundary Groove Portion

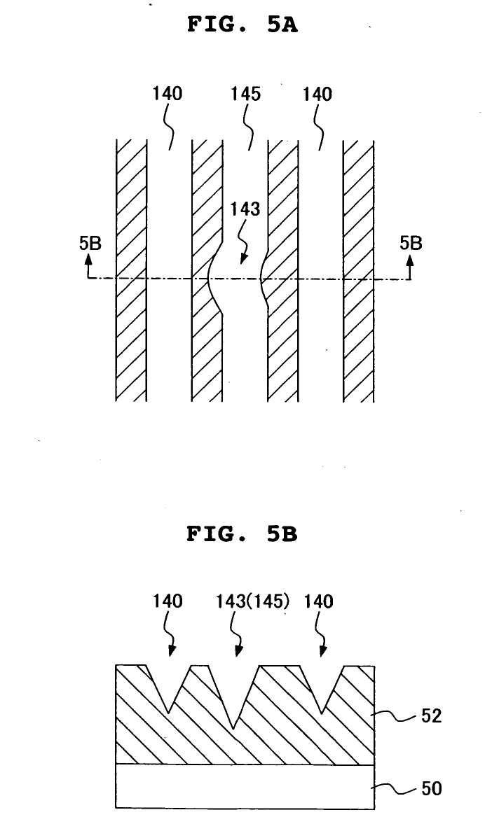

In the first (and second) groove formation area (areas) after the development, as shown in FIGS. 5A and 5B, a groove formation section 140 and an SLPP formation section 143 are formed on the glass master disk 51. Each of the groove formation section 140 and the SLPP formation section 143 is groove-shaped with a V-shaped cross section. The deeper V-shaped groove is formed at the SLPP formation section, because the exposure intensity is large (+4%) as compared with the groove portion. As for the groove of the boundary groove portion, the exposure is performed at the large intensity (Level 2) as compared with the groove of the adjoining groove portion. Therefore, in the boundary groove portion, the groove is formed to have a wider width and a deeper depth. Further, the groove portion is subjected to the setting so that the exposure intensity is increased from the inner circumference to the outer circumference. Therefore, the depth is continuously deepened from the inner circumference to the outer circumference.

The glass master disk having been developed as described above is subjected to the etching by using an unillustrated reactive etching apparatus. The etching is simultaneously performed for the in-groove pit portion and the groove portion. However, for the convenience of explanation, the in-groove pit portion and the groove portion will be separately explained.

Reactive Etching Process for In-Groove Pit Portion

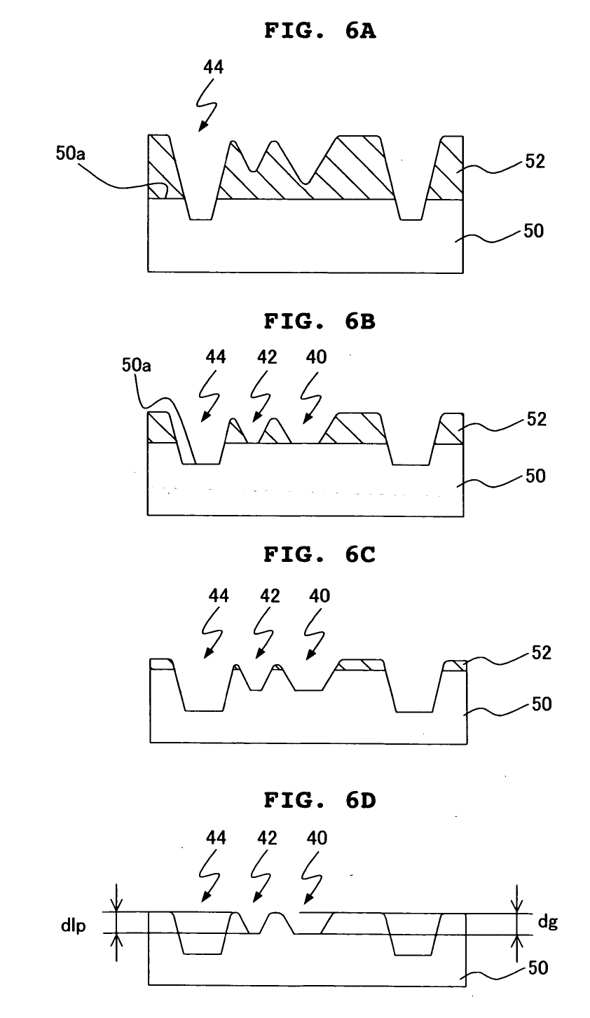

As shown in FIG. 6A, the surface of the photoresist 52, which was formed on the glass master disk 50, was subjected to the etching in a gas atmosphere of C₂F₆ by using an unillustrated reactive ion etching (RIE) apparatus. Accordingly, the in-groove pit formation sections 44 are etched until arrival at a depth of 90 nm from the surface 50a of the glass master disk 50 respectively. In this process, the etching amounts of the glass and the photoresist are about 2:1. Subsequently, as shown in FIG. 6B, in order to expose the surface 50a of the glass master disk 50 at the groove formation section 40 and the land prepit (LPP) formation section 42, an unillustrated resist ashing apparatus was used with 02 to erode the photoresist 52 by a predetermined thickness. Accordingly, the surface 50a of the glass master disk was exposed at the groove formation section 40 and the land prepit formation section 42. Further, as shown in FIG. 6C, RIE was performed in a gas atmosphere of C₂F₆+CHF₃ for the applied surface of the photoresist 52 of the glass master disk 50. Accordingly, the groove formation section 40 was etched until arrival at a depth of 170 nm from the surface 50a of the glass master disk. In this procedure, the etching amounts of the glass and the photoresist were about 3:1. The land prepit formation section 42 had the bottom surface which was the same as that of the groove formation section. Therefore, the depth dg to the bottom surface of the groove was the same as the depth dlp to the bottom surface of the land prepit (see FIG. 6D). The in-groove pit formation section 44 was etched until arrival at a depth of 260 nm from the surface 50a of the glass master disk. Subsequently, as shown in FIG. 6D, the resist ashing apparatus (not shown) was used again to remove the photoresist 52 from the glass master disk 50. Accordingly, the glass master disk 50 was obtained, which had the surface formed with the desired pattern.

Reactive Etching Process for Groove Portion and Boundary Groove Portion

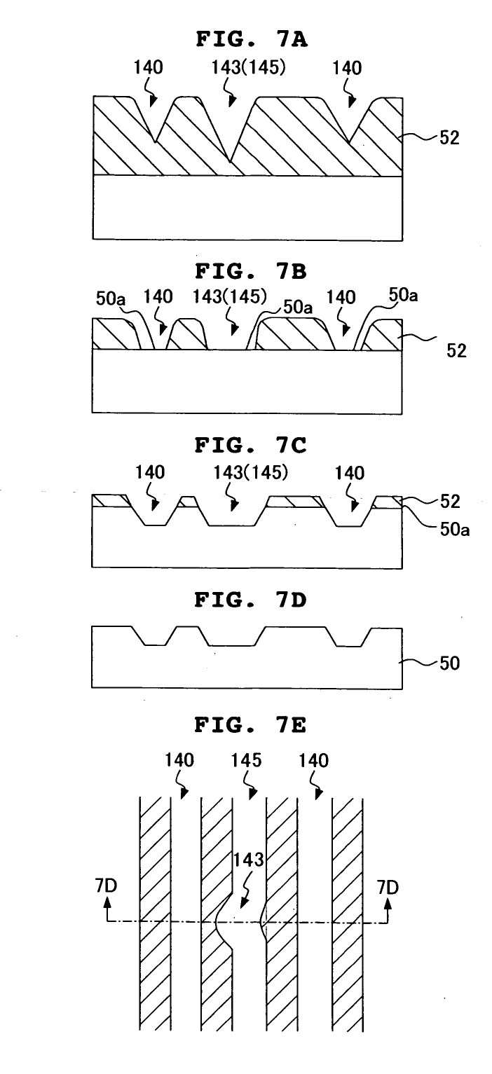

The reactive etching process for the groove portion and the boundary groove portion will be explained with reference to FIG. 7. In order to perform the process in the same manner as in FIG. 6, the unillustrated RIE apparatus was used to perform the etching as shown in FIG. 7A in a gas atmosphere of C₂F₆. A groove section 140, a boundary groove section 145, and an SLPP section 143 are not etched, because the glass surface is not exposed. Subsequently, as shown in FIG. 7B, the unillustrated resist ashing apparatus was used with O₂ to erode the photoresist 52 by a predetermined thickness. Accordingly, the surface 50a of the glass master disk was exposed at the groove section 140, the boundary groove section 145, and the SLPP section 143. Further, as shown in FIG. 7C, RIE was performed in a gas atmosphere of C₂F₆+CHF₃ for the formation surface of the photoresist 52 of the glass master disk 50. Accordingly, the groove formation section 140 was etched until arrival at a depth of 170 nm at the inner circumferential portion and a depth of 180 nm at the outer circumferential portion from the surface 50a of the glass master disk. The depth of the groove formation section was continuously deepened from the inner circumference to the outer circumference. Subsequently, as shown in FIG. 7D, the resist ashing apparatus (not shown) was used again to remove the photoresist 52 from the glass master disk 50. Accordingly, the glass master disk 50 was obtained, which had the surface formed with the desired pattern. FIG. 7E shows a plan view of the pattern of the obtained glass master disk 50.

Electroless plating was applied as a pretreatment for the plating to the pattern formation surface of the glass master disk 50 obtained as described above. Further, an Ni layer having a thickness of 0.3 mm was formed by the electroforming method by using the plating layer as a conductive film. Subsequently, the surface of the Ni layer formed on the glass master disk 50 was polished, and the Ni layer was exfoliated from the glass master disk. Thus, a stamper was obtained. The conductive film, which was adopted in the pretreatment for the plating as described above, may be formed by using the sputtering method or the vapor deposition method.

Method for Manufacturing Information-Recording Medium

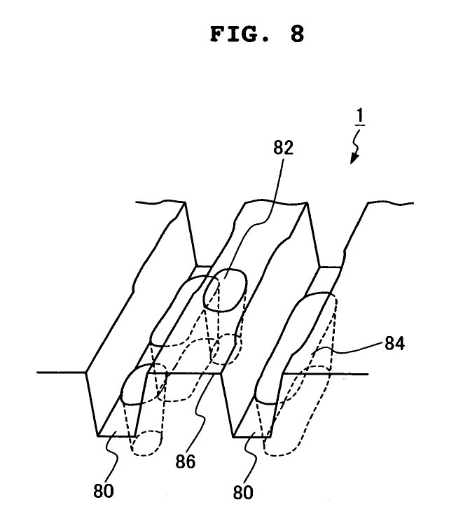

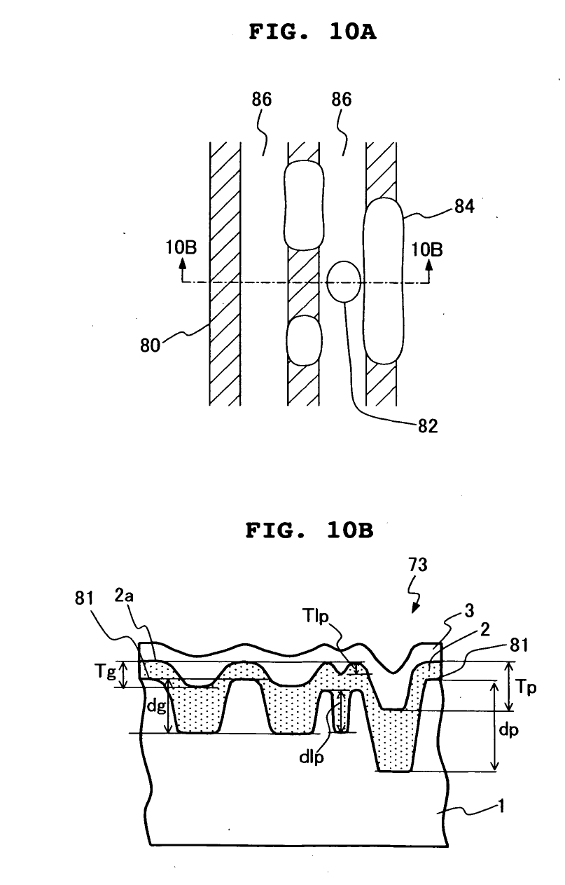

The stamper was installed to an existing injection molding machine, and the substrate 1 was obtained by the injection molding. The substrate 1 was a substrate made of polycarbonate having a diameter of 120 mm and a thickness of 0.6 mm. As shown in FIG. 8, the pattern, which has the same shape as the shape of the concave/convex pattern formed on the glass master disk, is transferred to one surface of the substrate 1. As shown in FIG. 9, those provided on the substrate 1 include the groove area 71, the boundary groove area 72, the in-groove pit area 73, the boundary groove area 74, and the groove area 75 in this order from the inner circumferential side of the substrate 1. Only the in-groove pit area 73 is magnified and depicted in FIG. 8. Lands 86 and grooves 80 are alternately provided in the in-groove pit area 73. The land prepits (LPP) 82 are formed on the land 86, and the in-groove pits 84 are formed on the bottom surface of the groove 80. FIG. 10A shows a plan view thereof. In particular, a scanning type probe microscope produced by Digital Instruments was used to measure the width in the substrate radial direction of the in-groove pit having the shortest channel bit length 3 T and the width in the substrate radial direction of the in-groove pit having the channel bit length longer than the above. The maximum width of the in-groove pit having the shortest channel bit length 3 T was 0.34 μm. The maximum width of the in-groove pit having the channel bit length of 11 T was 0.38 μm. Further, the maximum width of the in-groove pit having the channel bit length of 14 T was 0.4 μm. According to an experiment performed by the inventors, the ratio of the maximum width of the in-groove pit having the channel bit length longer than the shortest channel bit length 3 T with respect to the maximum width of the in-groove pit having the shortest channel bit length 3 T was within a range of 112 to 118%. It is appreciated that the width in the radial direction of the substrate is suppressed from being widened.

A solution, which had a concentration of 1% by weight of a metal-containing azo dye which is commonly used, was applied onto the pattern formation surface of the substrate 1 by using the spin coat method so that the thinness was 30 nm between the grooves, i.e., on the lands. In this procedure, the amount of application of the solution was 1 g. The substrate was rotated at a number of revolutions of 100 rpm for 30 seconds from the start of the application, and then the substrate was rotated at a number of revolutions of 800 to 1,000 rpm for 30 seconds. When the dye solution was applied, tetrafluoropropanol was used as a solvent to prepare the azo type dye solution thereby. The solution was filtrated through a filter to remove impurities. Subsequently, the substrate 1, to which the dye material had been applied, was dried at 70° C. for 1 hour, followed by being cooled at room temperature for 1 hour. Thus, the recording layer 2 was formed on the substrate 1 (see FIG. 10B).

Further, as shown in FIG. 10B, an Ag alloy was formed as the reflective layer 3 to have a thickness of 160 nm on the recording layer 2 by using the sputtering method. Subsequently, an unillustrated UV resin material was applied to have a thickness of 10 μm onto the reflective layer 3 by the spin coat method. Further, an unillustrated substrate made of polycarbonate (dummy substrate) having a thickness of 0.6 mm was placed thereon. In this state, the UV radiation was applied to the substrate on which the respective layers had been formed. Accordingly, the substrate formed with the respective layers was stuck to the dummy substrate to obtain the optical information-recording medium.

Groove Shape at In-Groove Pit Portion

The scanning type probe microscope produced by Digital Instruments was used for the optical information-recording medium obtained as described above to measure the maximum depths of the in-groove pit, the groove, and the land prepit in the in-groove pit area 73. As shown in FIG. 10B, the depths were defined as the depths from the surface of the land 81 of the substrate. The maximum depth dg of the groove was 160 nm, and the maximum depth dp of the in-groove pit was 260 nm. The maximum depth dip of the land prepit at the in-groove pit portion was the same as the maximum depth dg of the groove, i.e., 160 nm. The maximum depth of the boundary groove was 160 nm. Further, the scanning type probe microscope produced by Digital Instruments was used to measure the recording layer recess depths of the in-groove pit, the groove, and the first land prepit in the in-groove pit area 73. The recording layer recess depth herein refers to the maximum recess amount of the recording layer 2 on the basis of the surface 2a of the recording layer 2 formed on the land 81. The recording layer recess depth Tg of the groove was 100 nm, and the recording layer recess depth Tp of the in-groove pit was 170 nm. The recording layer recess depth Tlp at the land prepit of the in-groove pit portion was 90 nm.

Groove Shape at Groove Portion

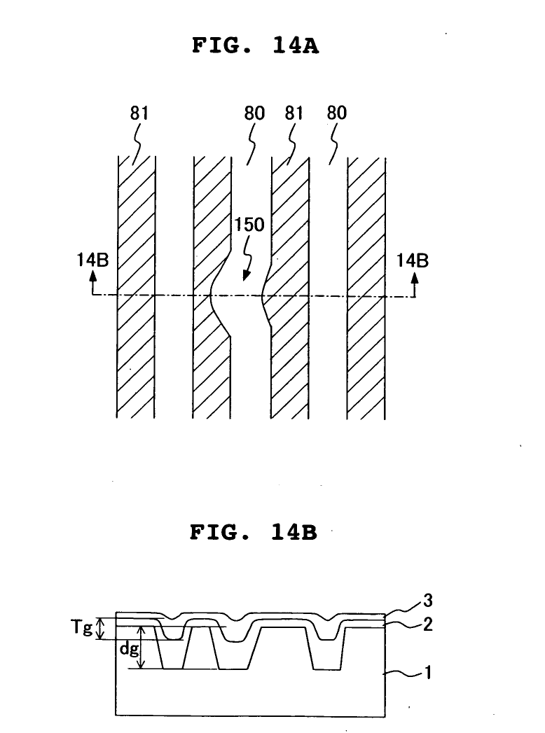

The scanning type probe microscope produced by Digital Instruments was used to measure the depths of the groove 80 and SLPP at the first and second groove formation portions. Schematic contours are shown in FIGS. 14A and 14B. The groove depth (height) dg was 160 nm at the inner circumference, and the groove depth (height) dg was 170 nm at the outer circumference. The SLPP portion 150 had the same or equivalent values. Further, the scanning type probe microscope produced by Digital Instruments was used to measure recess depths of the recording layer 2 in the groove 80 and SLPP in the groove formation area. The recording layer recess depths were defined in the same manner as described above. The recording layer recess depth Tg of the groove was 100 nm in the same manner as described above. The same or equivalent value was obtained for the SLPP portion 150 as well.

A recording signal in the in-groove pit area was reproduced on the optical information-recording medium obtained in the embodiment described above by using an optical pickup having a laser beam with a wavelength of 650 nm and a lens with a numerical aperture of 0.6. The signal was successfully detected and reproduced in a stable manner. In this procedure, the signal modulation degree of the reproduced signal was 61%, and the jitter was 7.2%. The satisfactory results were obtained in any case.

In the illustrative embodiment described above, the area has been explained, in which the in-groove pit and the boundary groove are disposed adjacently. However, the tracking error is not caused for the following reason, even when the tracking is performed in the area in which the in-groove pit and the groove portion in the boundary pit area are disposed adjacently. In addition to the fact that the light spot has a spot size to some extent, the scanning is performed in the direction in which the light spot is not perpendicular but the light spot forms a gentle angle with respect to the tracking direction when the tracking is actually performed. Therefore, when the boundary groove area is subjected to the tracking, any boundary groove portion is included in the light spot. Accordingly, the radial push-pull signal, which is obtained from the boundary groove area, is averaged. It is possible to suppress the disturbance of the radial push-pull signal between the in-groove pit area and the groove area during the tracking as compared with an optical information-recording medium having no boundary groove.

In the optical information-recording medium of the embodiment described above, polycarbonate is used for the substrate. However, it is also allowable to use, for example, polymethyl methacrylate and amorphous polyolefine.

### COMPARATIVE EMBODIMENTS

Next, an explanation will be made in comparison with the following first and second comparative embodiments about the fact that the characteristics such as those concerning the reproduction error and the like can be satisfied in any area by using, in the divided manner, the systems for recording the position information in relation to LPP for the in-groove pit portion and SLPP for the groove portion.

### First Comparative Embodiment

In this comparative embodiment, the position information was carried in both of the in-groove pit area and the groove area of a substrate of an optical information-recording medium by the land prepit system. That is, the optical information-recording medium was manufactured in the same manner as the embodiment described above except that land prepits were provided on the lands of the areas in place of SLPP provided in the first and second groove formation areas of the substrate 1 in the first embodiment. The land prepit had the same depth and the same width as those of the land prepit provided in the in-groove pit area. Information was recorded and reproduced on the obtained optical information-recording medium in the same manner as in the embodiment to measure the signal modulation degree and the jitter. PI error (Inner-code Parity (PI) error: value of measurement of error in compliance with the DVD standard, in which a measured value of not more than 280/8 ECC is the standard value) and AR (Aperture Ratio: an aperture ratio of LPP (SLPP) signal after recording) were determined in the in-groove pit area and the groove area. The determined results are shown in Table 1 in comparison with the results obtained for the optical information-recording medium of the embodiment. The results obtained in the ×8 speed recording are shown for the groove.

### Second Comparative Embodiment

In this comparative embodiment, the position information was recorded in both of the in-groove pit area and the groove area by the SLPP system. That is, an optical information-recording medium was manufactured in the same manner as in the embodiment described above except that SLPP was provided in place of LPP provided in the in-groove pit area in the first embodiment. SLPP, which was provided in place of LPP, had the same wobble amount as that of SLPP provided in the groove area. Information was recorded and reproduced on the obtained optical information-recording medium in the same manner as in the embodiment to measure the signal modulation degree and the jitter. PI error and AR were determined in the in-groove pit area and the groove area. The determined results are shown in Table 1 in comparison with the results obtained for the optical information-recording media of the embodiment and the first comparative embodiment.

TABLE 1

| | |
|---|---|
| In-groove pit area | Groove area |

| | PI error | AR | PI error | AR |
|---|---|---|---|---|
| Embodiment | 30 | 40% | 50 | 23% |
| First comparative | 35 | 43% | 240 | 8% |
| embodiment | | | | |
| Second comparative | 900 | 6% | 45 | 22% |
| embodiment | | | | |

PI error as referred to in Table 1 is prescribed to be not more than 280 in the Book standard. However, in order to secure the compatibility with respect to various drives, PI error is required to be not more than 100 and desirably not more than 50. AR is prescribed to be not less than 15% in the Book standard. According to these viewpoints, any characteristic, which satisfies the standard, is not obtained as the characteristic of the groove portion (user portion) in the first comparative embodiment. Further, in the case of the second comparative embodiment, the characteristic of the in-groove pit portion is lower than the value specified in the standard. It has been successfully confirmed that the optical information-recording medium of the present invention is useful in order to obtain the satisfactory characteristics for both of the in-groove pit portion and the groove portion.

Form of Disk

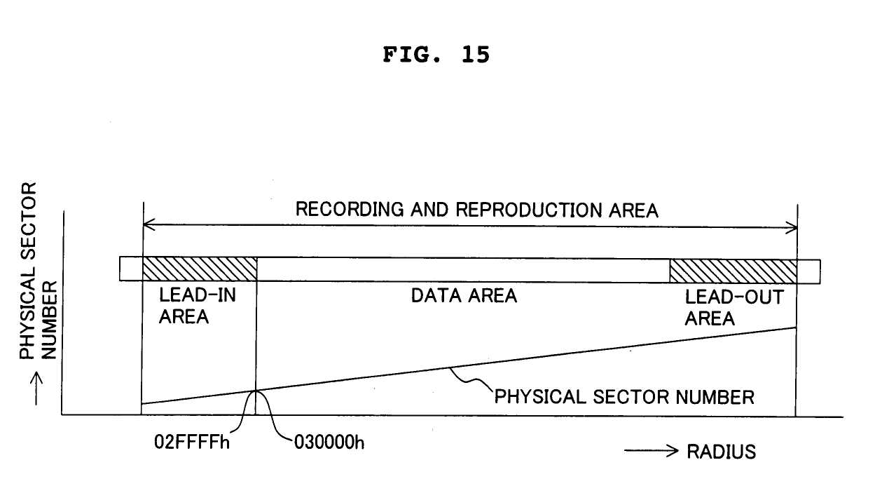

The specified structure of the information-recording medium based on the use of the embodiment will be explained. FIG. 15 shows a sector structure arranged on DVD-R. The structure includes Lead-in, Data area, and Lead-out in this order from the inner circumference. Data area starts from Physical sector number: 030000 h. In the recording and reproduction area, the wobble is made in the radial direction at a frequency of about 140 kHz at a distance of about 1.3% to 2.7% with respect to the track pitch. In the present invention, the wobble amount was 0.2%. When the track pitch is 0.74 μm, the wobble amount is about 0.015 μm. Land prepits LPP, which possess the information such as the address, are arranged in the land area in the recording and reproduction area.

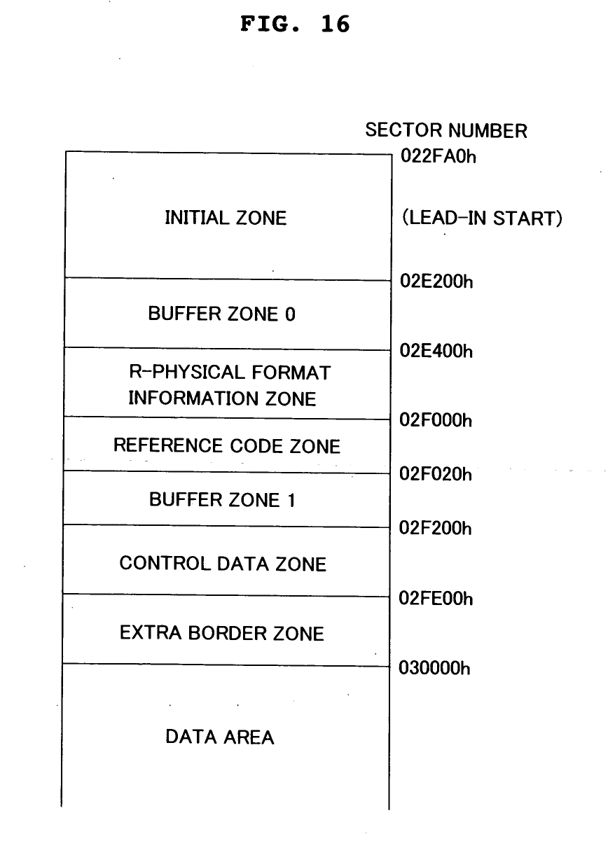

As shown in FIG. 16, Lead-in area is composed of Initial zone, Buffer zone 0, R-Physical format information zone, Reference code zone, Buffer zone 1, Control data zone, and Extra Border Zone in this order from the inner circumference of the recording and reproduction area. Control data zone (in-groove pit area), which is the read-only area, is provided with the groove (170 nm in the case of λ=650 nm) having a depth of about λ/2.4n (n: refractive index of the substrate) from the land portion with respect to the recording and reproducing wavelength λ, and the pit (260 nm in the case of λ=650 nm) of about λ/1.6n, which possesses the read-in information including, for example, the information about the copyright protection, the recording strategy information, the disk type, and the version. The groove shape in the recording and reproduction area except for Control data zone has a depth of 170 nm of about λ/2.4n.

When the reproduction operation is performed on the optical information-recording medium of the present invention, the seek operation is performed toward Control data zone. However, when the boundary area such as the boundary pit and the boundary groove is provided for each one track or several tracks at the inner and outer circumferential portions adjacent to Control data zone (in-groove pit area), then the disturbance of the radial push-pull signal is suppressed, and it is possible to reproduce the information in Control data zone without any failure of the tracking. Further, when a relationship of 1<W₂/W₁<1.2 is satisfied for the widths of the first pit and the second pit formed to be longer than the first pit in Control data zone, and a relationship of 0.4≦dlp/dg<1 is satisfied provided that dlp represents the height of the side wall of the land prepit from the bottom surface of the groove and dg represents the height of the land from the bottom surface of the groove because the height is the same as the depth from the land surface, then LPP is detected in a well-suited manner, and the reproduction error is in a satisfactory state as well.

The optical information-recording medium obtained in the embodiment was used to reproduce the recording signal from Control data zone (in-groove pit area) by using an optical pickup having a laser beam with a wavelength of 650 nm and a lens with a numerical aperture of 0.6. The signal was successfully detected and reproduced in a stable manner. In this procedure, the signal modulation degree of the reproduced signal was 61%, and the jitter was 7.2%. The satisfactory results were obtained in any case.

Therefore, the recording strategy, which is required during the recording, can be reliably detected. It is possible to faithfully set the condition for various drives, and it is possible to perform the recording with few errors.

In the recording operation on the optical information-recording medium of the present invention, when the operation proceeds to deal with Data area via Control data zone and Extra Border Zone, the recording can be started in a well-suited manner as well from Physical sector number: 030000 h in Data area, because LPP having the address information is satisfactorily detected.

1. An information-recording medium comprising a substrate in which a plurality of lands and grooves are formed and a plurality of tracks are comparted, and a recording layer and a reflective layer which are formed on the substrate, wherein:
the grooves include a first groove; a second groove in which pits are formed; and a third groove which is arranged between the first groove and the second groove and which has a groove width wider than a width of the first groove;
pits, which indicate position information, are formed on the land disposed in an area in which the second groove is formed; and
shifted land prepits which indicate position information are provided in areas in which the first and third grooves are formed.

2. The information-recording medium according to claim 1, wherein the information-recording medium is disk-shaped, the first groove includes a plurality of grooves, and the grooves have widths which are continuously widened from an inner circumference to an outer circumference of a disk.

3. The information-recording medium according to claim 1, wherein the recording layer is formed of a dye material.

4. The information-recording medium according to claim 3, wherein the dye material is an azo dye material.

5. The information-recording medium according to claim 1, wherein management information is recorded in the area in which the second groove is formed.

6. The information-recording medium according to claim 5, wherein the management information includes write strategy.

7. The information-recording medium according to claim 5, wherein the management information includes copyright information.

8. A method for producing an information-recording medium, comprising:
providing a substrate in which a plurality of lands and grooves are formed and a plurality of tracks are comparted; wherein the grooves include a first groove, a second groove in which pits are formed, and a third groove which is arranged between the first groove and the second groove and which has a groove width wider than a width of the first groove; pits, which indicate position information, are formed on the land disposed in an area in which the second groove is formed; and shifted land prepits which indicate position information are provided in areas in which the first and third grooves are formed;
providing a recording layer on the substrate; and
providing a reflective layer on the recording layer.

9. The method according to claim 8, further comprising, when the substrate is provided:
exposing a photosensitive material formed on a master disk at a first exposure intensity to form a first groove pattern;
exposing the photosensitive material to form at least a pattern corresponding to the third groove thereon by performing the exposure while making change to a second exposure intensity which is higher than the first exposure intensity; and
exposing the photosensitive material to form a pattern corresponding to the pits in the second groove thereof by exposing the photosensitive material at a third exposure intensity which is higher than the second exposure intensity.

10. The method according to claim 9, further comprising using a beam which is different from a beam for performing the exposure to form the patterns of the first and third grooves when a pit pattern is formed on a portion corresponding to the land in the area of the second groove.

11. The method according to claim 10, further comprising forming the patterns by developing the master disk and forming the substrate by using the master disk formed with the patterns.

12. The method according to claim 11, wherein the master disk is disk-shaped, and the first exposure intensity is continuously increased when the photosensitive material is exposed from an inner circumference to an outer circumference of the master disk.

13. The method according to claim 9, further comprising making the exposure intensity to be zero before and after the exposure to form the patterns corresponding to the second groove and the pits in the second groove.

14. The method according to claim 11, further comprising performing etching with RIE when the master disk is developed.

15. The method according to claim 8, further comprising providing the substrate by performing injection molding with a stamper in which management information is previously formed with pits, forming a dye recording layer by spin coat on the substrate, forming the reflective layer on the recording layer, and forming a UV resin layer on the reflective layer.

16. The method according to claim 15, wherein the management information includes write strategy.

17. The method according to claim 15, wherein the management information includes information about copyright protection.
